(19) United States
(12) Patent Application Publication
(10) Pub. No.: US 2020/0060460 A1
(43) Pub. Date: Feb. 27, 2020

(54) SHIPPED PARCEL SECURE RECEIPT SYSTEM

(71) Applicant: Dynamis Solutions, Inc., Las Vegas, NV (US)

(72) Inventors: Hailey Farrar, Las Vegas, NV (US); Dallas Simonette, Las Vegas, NV (US)

(73) Assignee: Dynamis Solutions, Inc., Las Vegas, NV (US)

(21) Appl. No.: 16/108,876

(22) Filed: Aug. 22, 2018

(51) Int. Cl. A47G 29/20; A47G 29/14; E05B 73/00

(52) U.S. Cl. CPC A47G 29/20; E05B 73/0005; A47G 29/141

(57) ABSTRACT

An apparatus for securing a delivered package to an immoveable stationary structure is disclosed. The apparatus comprises a controlled access container, an anchoring device and a tethering structure for securing the container to the anchoring device. A method of securing a package being delivered to an intended delivery location is disclosed. The method comprises providing an anchor that is capable of securing a tethering device to a stationary structure, providing a controlled access container, and providing a tether that secures the anchor to the controlled access container. A lock is provided on the controlled access container. A removeable anchoring mechanism is disclosed having three portions, each portion positioned such that the anchoring mechanism wraps around an edge of a door and fits securely within the door jam. An expanded portion prevents the mechanism from being pulled through the door and a locking mechanism secures a tether to the stationary door.

The present invention relates to preventing theft of parcels delivered by a delivery service. In particular, it relates to apparatuses and methods for containing and securing delivered packages until the recipient can retrieve the package from the point of delivery, and for preventing “snatch and run” package thefts.

### BACKGROUND OF THE INVENTION

Consumers are now purchasing a wide variety of goods from online merchants such as Amazon, eBay, Walmart, Target, Wayfair, Overstock and numerous other online merchants. There is increased demand for parcel delivery services that can deliver goods to the doorstep of the online customer. Examples of delivery services that deliver goods purchased online include the U.S. Postal Service, U.P.S, Fed Ex ground, D.H.L. and Fed Ex air. In addition, there are other types of ground carriers, such as drug store delivery services and truck lines that deliver a wide variety of items to the doorstep of the customer, often when the customer is not home to receive and secure the package.

The delivery service is only responsible for the parcel until it is delivered to the destination. After the final delivery is logged, the risk of loss is transferred to the purchaser. This presents a significant problem for the average purchaser who is hoping the package is not stolen before the package can be retrieved. Some credit card companies will cover these losses, but for most purchasers, the loss is born by the customer. This deters people from ordering goods online, especially if his or her front doorstep is in clear view of passersby.

Although parcels can have a wide variety of size, weight and overall dimensions, a vast majority of the parcels that are delivered to a residential customer are approximately 18 inches wide by 14 inches long by 8 inches deep or smaller. Many of these packages contain items of clothing, footwear or small household items and the weight of the parcel is 5 pounds or less. The portable size and the light weight of these parcels make them attractive to would-be thieves that notice the parcel sitting unattended on the front porch or stoop of the buyer and snatch it.

It is not uncommon to see video footage of thieves on the local news stealing packages in broad daylight while being filmed by the homeowner or apartment dweller's security cameras. Some theft rings follow delivery trucks and steal parcels shortly after they have been delivered. Parcel delivery services have tried to combat this problem by hiding parcels so that they cannot be seen by a passerby. Some delivery personnel deliver parcels to a back door or place the parcels behind a fence, bushes or a half wall to prevent would-be thieves from seeing the parcel.

Online merchants have attempted to solve the problem in a variety of ways. One way is by providing storage lockers for delivery of parcels to a centralized location, such as at a local gas station. Other online merchants recommend delivery to a local post office where the parcel can later be retrieved by the recipient. Apartment and condominium managers have been forced to provide parcel delivery lockers or parcel delivery office services to its tenants to provide the needed security to prevent package theft. Dedicated storage space and sometimes personnel must be allocated to protect these packages from theft. This costs the building owners money and is a contributing factor to the increasing cost of renting an apartment.

These centralized package holding systems require the consumer to coordinate a trip to retrieve packages. Although some solutions, such as providing storage lockers at a local gas station is convenient from the perspective of 24-hour access, it requires the consumer to spend time retrieving the package. One motivation for shopping online is to save time, and spending time retrieving articles from secure locations is counter to this motivation.

Some centralized systems require the consumer to retrieve the package during the hours of operation of the secure package receipt center, further frustrating the consumer's goal of not wasting time and rapidly gaining access to the parcel. If these hours of operation are normal business hours, the average working consumer cannot retrieve the package at all without the help of a friend or a special weekend trip to retrieve the package.

It would be desirable to provide a secure apparatus and method for preventing the theft of items delivered to the doorstep of a customer who has purchased a product from an online merchant or local brick and mortar merchant that provides home delivery. It would also be desirable to provide an enclosure for a delivered package that is resistant to moisture and the weather and protects the package from destruction or damage.

### SUMMARY OF THE INVENTION

An apparatus for securing a delivered package is disclosed. The apparatus includes a controlled access container adapted to receive a package delivered to a delivery location and an anchoring device for anchoring the controlled access container to a stationary structure at the delivery location.

A method of securing a package being delivered to a delivery location includes the following steps, including providing an anchor that is capable of securing a tethering device to a stationary structure at the delivery location, providing a controlled access container that permits insertion of a package, wherein the container has a connecting mechanism for connection to the tether, providing a tether that secures the anchor to the controlled access container and provides a locking mechanism on the controlled access container that secures a delivered package to the tether until the intended recipient of the package unlocks the locking mechanism.

A removeable anchoring mechanism configured for use with a pivoting door is disclosed. The mechanism includes: an elongated member with a length, width and thickness, configured to contact at three adjacent planes of a door, one of the planes comprising an edge of a door, having at least three portions, the first and second portions joined together at an angle of approximately 90 degrees, and the second and third portions joined together at an angle of approximately 90 degrees. The elongated member is positionable on a door edge between the door and a door jam when the door is in an open position and is anchored between the door and door jam when the door is in the closed position. The mechanism includes an expanded portion on the first portion configured to prevent the elongated member from being pulled through the space between the door and an adjacent door jam when the door is in the closed position, and a locking mechanism on the third portion for securing a tether to the anchoring mechanism.

### DESCRIPTION OF THE DRAWINGS

FIG. 1 is a perspective view of an exemplary security device of the present invention installed in an exterior door between the door frame and the door.

FIG. 2 is a perspective view of an embodiment of the present invention.

FIG. 3 is an expanded view of a composite multi-layer material used to form an example of a controlled access container of the present invention.

FIG. 4 is a cross-sectional view along line A-A as shown in FIG. 1.

FIG. 5 is a perspective view of an example of a removeable anchoring device fixedly connected to a tether.

FIG. 6 is a cross-sectional view of a second rolled end of an anchor of an embodiment of the invention.

FIG. 7 is a perspective view of an embodiment of the present invention that may be used in connection with an exterior door and a corresponding storm door.

FIG. 8 is a perspective view of various embodiments of anchoring and tethering devices of the present invention.

### DETAILED DESCRIPTION

The present invention is an apparatus for preventing the theft of a package that has been delivered to an intended location such as the front doorstep of the recipient's home. A preferred apparatus is capable of being locked by the delivery person without special codes, keys or any special instruction. In one form of the invention, the delivered package is inserted into a controlled access container that is lockable, and resistant to being opened with ordinary tools such as a jack knife, scissors, utility knives or wire cutters. In some embodiments, the container is also weather resistant and waterproof or water resistant.

According to one example of the invention, an apparatus for securing a delivered package is disclosed. The apparatus comprises a controlled access container adapted to receive a package delivered to a delivery location. The apparatus includes an anchoring device for anchoring the controlled access container to a stationary structure at the delivery location. A tethering device may be provided to attach the controlled access container to the anchor. One example of a controlled access container of the present invention is a flexible fabric container. The container, tether and anchor can be folded into a small size and stowed away when not in use. The container in some embodiments includes a security layer adjacent to a flexible fabric exterior. This security layer is formed of a flexible metal mesh structure in some embodiments. The flexible metal mesh structure in one form of the invention comprises a mesh formed of wire cable. In another form of the invention the security layer is formed as a wire mesh screen. In yet other embodiments, the security layer is formed of expanded metal.

In one embodiment of the invention, the controlled access container comprises a closing mechanism and a locking mechanism. The closing mechanism includes a series of grommets and a locking cable that is threaded through the grommets. The locking cable in examples of the invention is a one-way locking mechanism. That is, the delivery person may draw the cable tight through the grommets, closing the container, threading one end of the cable through a loop in the tether to anchor the container to a stationary object, and then through a one-way sliding lock to prevent unauthorized access to the interior of the container. Only the intended recipient may open the lock. The lock in some embodiments is a combination lock and in other embodiments is a keyed lock. In other embodiments the lock is an electronic lock that may be opened by means of a wireless controller such as a fob or a cell phone.

In one or more embodiments, the controlled access container is built out of a flexible fabric that in embodiments is weather proof and, waterproof. Some embodiments of the container include a protective flap (not shown) covering the closing mechanism and keeping rain from entering the container. The container in embodiments is a bag with a base, four sides and a top edge. The walls and base of the flexible bag in embodiments is formed of a multi-layer fabric. The fabric may be water proof. At least one layer is a security layer in some examples of the invention. Near a top edge and spaced apart from the top edge, a plurality of grommets is provided and extend through each of the layers and are configured for receiving a closing cable. In some embodiments, the security layer surrounds the grommets such that the grommets and closing cable cannot be pulled away from the bag without also destroying the security layer.

In embodiments, the anchoring device is a removeable locking body shaped to fit around at least three adjacent surfaces of a hinged exterior door of a stationary structure. The locking body in one embodiment is positionable above a middle hinge of an exterior door, between the door jam and the edge of the door.

In examples of the invention, the anchoring device includes a connector for connecting the anchoring device to a tethering device. The tethering device in one example of the invention is one or more cables that connect the container to the anchor. The attachments of the tether to the anchor and the tether to the container may be permanent or removeable attachments.

One example of a tethering device is a metal cable with at least one loop at a first end. The opposite end in examples is fixedly attached to an anchoring mechanism, and in other embodiments is removably attached to an anchoring mechanism.

In some examples of the invention, the anchoring device is mounted between a door jam of a moveable door and an adjacent door edge. The moveable door is rotatable about its hinge but is immoveable from the intended delivery location without the use of tools, and access to the interior of the structure. In other words, it is immoveable by an unintended recipient unless that recipient goes to a great deal of effort to remove the entire door from its frame. Such action is highly unlikely for an opportunistic thief who will only steal packages if it can be done quickly and without great effort.

The apparatus of the present invention may include several alternate anchoring mechanisms. For example, an eye bolt, washer and nut could be used to provide a stationary anchor into the front wall of the house, next to the door, in the door jam or even through the door itself. A removeable anchoring mechanism adapted for use in a screen door jam, a window sill or a sliding door could alternatively be provided. An eye bolt could be installed through a window frame or a door frame. In some embodiments, the tether may be used as an anchor by wrapping the tether around a stationary post or a poll and threading the tether through a loop at one end of the tether. A concrete anchor could be installed into a cement slab, or into the foundation wall of the structure. The tether could be self-wrapped around a fence or deck post.

Although in the following described embodiment the anchoring device is removeable, it may also be permanently installed into the structure and is stationary.

A method of securing a delivered package at a delivery location is disclosed. The method includes providing an anchor that can secure a tethering device to a stationary structure at the delivery location and providing a controlled access container that permits insertion of a package, wherein the container has a connecting mechanism for connection to the tether. The method also includes providing a tether that secures the anchor to the controlled access container and providing a locking mechanism on the controlled access container that secures a delivered package to the tether until the intended recipient of the package unlocks the locking mechanism.

The method in some embodiments includes providing an anchor with a locking body that is removably insertable into a door hinge and becomes anchored between a door jam and an edge of a door when the door is closed and locked. In embodiments, the tether comprises a cable with at least one loop for connection to the controlled access container and an opposite end fixedly attached to a locking body.

A removeable anchoring mechanism configured for use with a pivoting door is disclosed. Examples of the present invention include at least the following components. An elongated member with a length, width and thickness is provided. The elongated member is configured to contact three adjacent planes of a door, one of the planes comprising an edge of a door. The elongated member has at least three portions, the first and second portions joined together at an angle of approximately 90 degrees, and the second and third portions joined together at an angle of approximately 90 degrees, forming a U shape, wherein the elongated member is positionable on a door edge between the door and a door jam when the door is in a closed position. In one embodiment, the anchoring mechanism is positionable just above a center hinge of an exterior door. Embodiments include an expanded portion on the first portion of the elongated member. The expanded portion increases the thickness of the first portion and is configured to prevent the elongated member from being pulled through the space between the door and an adjacent door jam when the door is in the closed position. Embodiments of the present invention include a locking mechanism on the third portion of the elongated member for securing a tether to the anchoring mechanism. In embodiments, the expanded portion is a rolled end. At a second opposite end of the elongated member, a locking device is provided to anchor a tether to the locking device. In one embodiment, this locking device is a rolled end with a channel for receiving an end of a tether, such as a metal cable. The metal cable in embodiments terminates with an enlarged end that cannot be pulled through the channel.

The locking mechanism of the present invention may be integrated into a tether or may be lockable to a tether. In one embodiment, the tether is a length of cable with a first enlarged end that is threaded through the channel of the rolled second end, and an opposite end having a fixed loop that is also too large to be pulled through the channel. The second loop is configured to cooperate with a locking mechanism of a separate controlled access container.

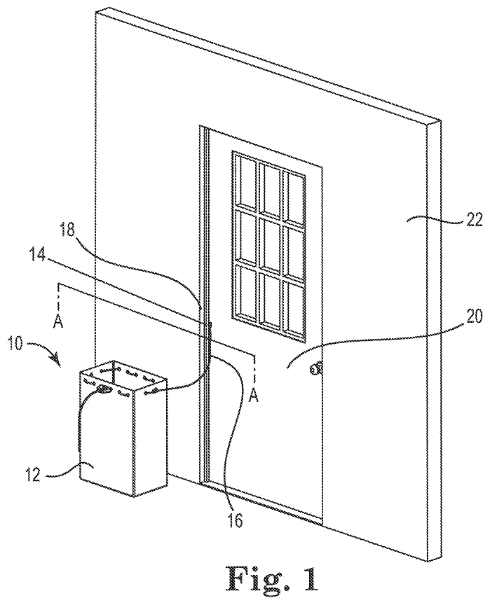

Referring now to FIG. 1, one example of a secure package delivery system 10 of the present invention is shown. The system includes a controlled access container 12, and an anchoring device 14, which in this embodiment is removeable. Also included as part of the system is a tethering device 16 that is connected to the anchoring device 14 as well as the controlled access container 12, as will be described in more detail below.

As shown in the drawing, the anchoring device 14 is configured such that it can be placed between the door jam 18 and an exterior door 20 of a stationary structure 22 such as a residential home, condominium or apartment. Systems of the present invention may also be used on moveable structures such as recreational vehicles, campers, storage containers and portable office buildings, portable class rooms and other structures that cannot be moved without the use of equipment such as an engine, tow truck, pick-up truck, crane, or flatbed trailer, for example. In another example, the anchoring device is configured to attach to other locations, such as a door knob. What is important is that the structure cannot be moved by one or more persons in a “grab and dash” theft event.

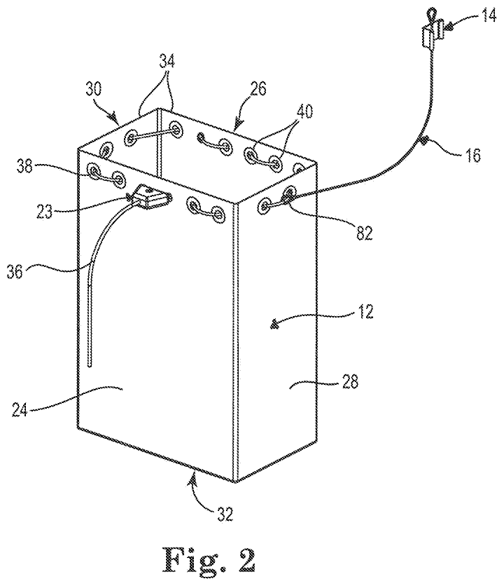

FIG. 2 is a perspective view of one example of a controlled access container of the present invention. The controlled access container 12 in one embodiment is formed of a flexible material that permits the user to fold the container for storage when the system is not in use. In one embodiment, the controlled access container 12, the tether 16 and the anchoring device 14 remain connected when in use and when not in use. The user simply removes the assembly from storage, unfolds and places the container in front of the door and within range of the tether 16, and positions the locking mechanism 14 above the center hinge in the door 20 and closes the door when the user is expecting to receive a package. The package is secured within the container with a one-way sliding lock, which will be described in more detail below. After the customer returns to his or her home or other stationary structure, the user unlocks the sliding lock, removes the package, removes the anchoring device 14 from the door and stows away the assembly 10 until the next online purchase is expected to be received.

As shown in FIG. 2, the controlled access container 12 in one embodiment is rectangular, with four sides, 24, 26, 28, 30 and a base 32. A closing mechanism 36 is provided spaced apart from the top edge 34 to secure a package in the container 12. The top portion of the container 12 is open in this embodiment. In other embodiments, the top is closed such as by means of a flap (not shown), which is anchored to the sides 24, 26, 28 and 30 with a metal zipper, or other suitable locking devices such as metal loops that extend through reinforced openings such that a cable can be threaded through each loop to restrict access.

In one embodiment, the closing mechanism 36 includes a wire cable 38 threaded through grommets 40 that are spaced apart from the top edge 34 and extend around the perimeter of the top portion of the container 12. The wire cable 38 in one embodiment is threaded through a loop 42 of the tether 16 to secure the container 12 to the tether when both ends of the wire cable 38 are drawn together and locked by sliding lock mechanism 23.

The sliding lock mechanism 23 is only one example of a device for drawing the ends of wire cable 38 together to prevent unauthorized access to the contents of the container 12. Other mechanisms could be used, such as a cable that is threaded through a sewn channel or flap, a clamp, a locking zipper, or the like. The locking mechanism 23 may be opened by the owner of the system with a key, with a combination or with an electronic access device such as a fob.

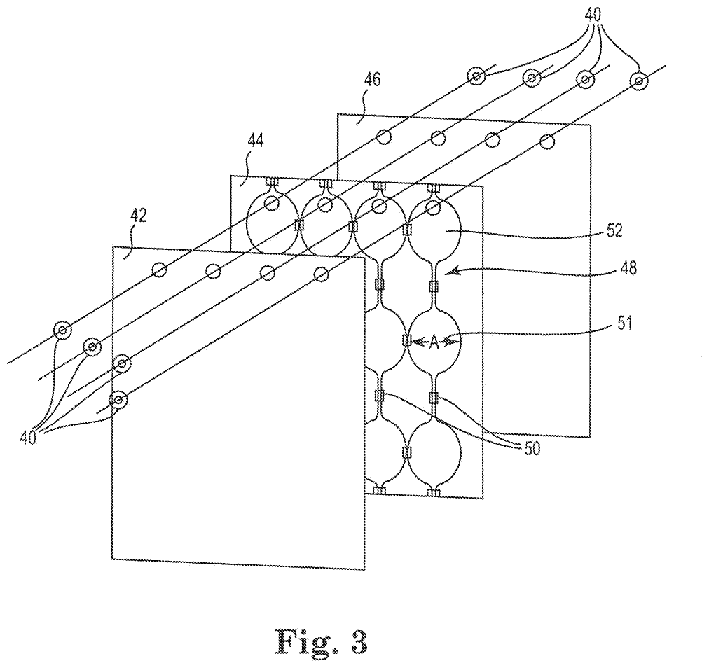

Further details of the materials of construction of one example of the controlled access container 12 is shown in FIG. 3. FIG. 3 is an expanded view of one side 24 of the container 12. The container 12 in one example of the invention is formed of a three-layer composite material. The outer layer 42 and inner layer 46 are preferably constructed of ballistic rip-stop nylon that is water proof and resistant to tearing and or cutting with a scissor or knife. An example of suitable rip stop 100% nylon 600 denier, available from Dongguan Tongli Textile Co, Ltd. Guangdong, China. This type of material is well known for use in constructing outdoor products such as tents, suitcase material, backpacks and horse blankets.

The middle layer 44 is a security layer. This layer in some embodiments is formed of a cable netting 48, formed from wire rope between 30 and 60 one-thousands of an inch in diameter. The wire rope may be tied together with crimping fasteners 50. Wire rope is used in one embodiment because it is both resistant to cutting and is flexible. In one example, the openings A 51 are 2-3 inches in width. The security layer 44 is highly resistant to being cut open with scissors or a knife. In some embodiments, the layer is formed from a metal wire netting. In other examples, it is formed from expanded metal. The wire rope netting 48 in one example is very resistant to cutting with hand tools such as scissors, knives and wire snips.

The layers 42, 44, 46 are bonded together with adhesive (not shown) either before, during or after assembly of the container 12. One suitable adhesive is manufactured by 3M Corporation of St. Paul, Minn. and is sold under the name Super 77 Contact Cement. Grommets 40 are formed of metal in one embodiment and are positioned such that the grommets are surrounded by the reinforcing security layer, making it much more difficult to destroy the closing mechanism 36 if a thief tries to access the container 12 by attempting to destroy the closing mechanism 36. The grommets may be press fitted into place, rotated into place or fixed to the wall of the bag using adhesive.

After the three layers 42, 44, 46 are bonded together and the container 12 is assembled, the grommets 40 are positioned within enclosed areas 52 of the security layer, making it much more difficult for a thief to pull the container 12 open by attempting to tear off the closing mechanism 36. Other constructions are contemplated by the present invention. For example, an exterior bag constructed of a waterproof material combined with an interior security bag formed of the reinforced security material is used in another example of the invention. Although a thief may successfully cut open the bag, the would-be thief will be surprised to find an interior security bag that is resistant to small tools such as a utility knife or conventional switch blade knife.

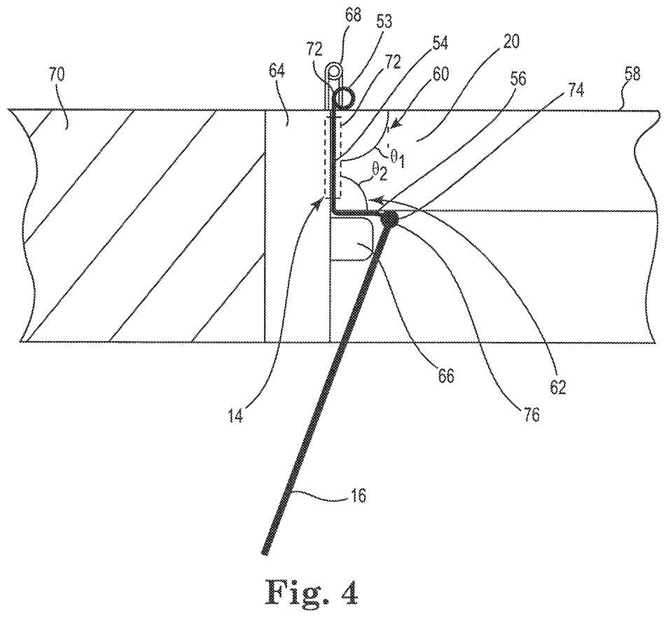

Referring to FIG. 4, an example of an anchoring device 14 is shown in cross-section when positioned around a door and alternative embodiment of the apparatus of the present invention is illustrated. The anchoring device 14 in one embodiment is an elongated member with a length, width and thickness. In one embodiment the entire anchoring device is formed of stainless steel sheet having a range of thicknesses between 0.060″ and 0.080″ inches, having an approximate length before shaping of 6 inches long×1 inch wide. In another example, the anchoring device 14 is formed as an aluminum extrusion.

The anchoring device 14 has a first portion 53 that contacts a substantially flat interior surface 58 of an exterior door 20. The second portion 54 has a substantially flat shape and is in a plane that is at an angle 60 of approximately 90 degrees with respect to the plane of the first portion 52. The anchoring device has a third portion 56 that has a flat surface that is at an angle 62 of approximately 90 degrees with respect to the angle of the second portion. The three portions 53, 54 and 56 together are arranged in a modified U cross-sectional shape and are of a size and thickness to fit between the door 20 and the door frame 64, and in one embodiment, to also fit around door jam 66.

In one embodiment, the anchoring device 14 is positionable directly above the center hinge 68 of an exterior door 20, the door 20 installed in an exterior wall 70 of a stationary structure. The interior faces 72 of the hinge or in other embodiments, the hinge itself form a seat for supporting the anchoring device 14 until the door is shut.

At a distal end of the first portion 53 is an expanded portion that is formed by rolling the end 53-A onto itself, the expanded portion preventing the anchoring device 14 from becoming dislodged if an intruder pulls on the tether 16. At the proximal end of the third portion 56 is a second rolled end 74 with a central longitudinal channel 76 adapted to receive a first end of the tether 16.

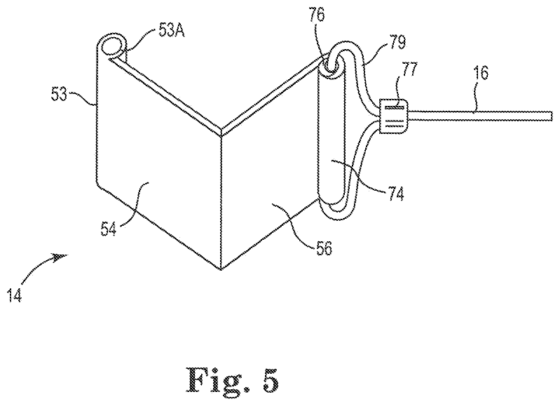

In an embodiment shown in FIG. 5, the tether 16 is formed from 1/8 inch diameter metal cable. The tether 16 is threaded through channel 76 and connected at point 77 by means of a fastener such as a clamp or a crimping connector, forming a loop 79 that is fixedly attached to the anchor 14.

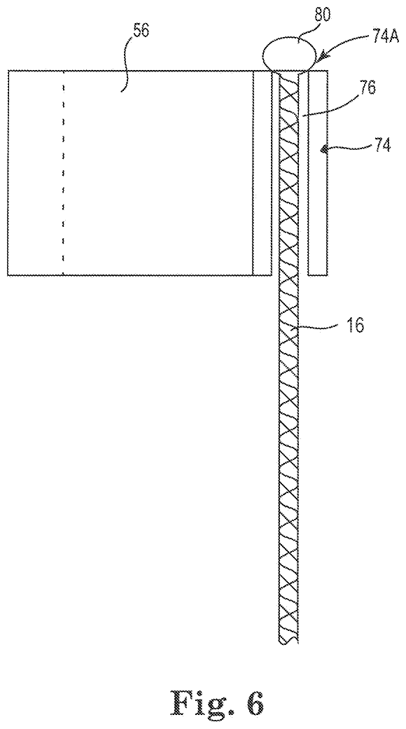

Another type of tether 16 as shown in FIG. 6 in one embodiment is formed from a durable metal cable having a diameter of between ⅛ and ¼ inches. The metal cable may be plastic coated or uncoated and in one embodiment is formed from 316 stainless steel twisted wire. This cable is resistant to cutting with hand tools such as knives, scissors or wire snippers. In one embodiment, a first end 74A of the tether 16 is enlarged by attaching a mounting stop 80, for example on the end by means of welding or crimping to prevent the cable from being pulled through the channel 76 in the second rolled end 74. Other attachment methods are contemplated such as by providing a welded loop (not shown) extending from the third portion 56 for receiving a closed loop (not shown) on the first end of the tether 16.

Although the tether in one example of the invention is formed from wire cable, the tether may be formed of wire rope, chain or other durable material that is resistant to cutting with hand tools.

As shown in FIG. 2, the opposite end of the tether 16 may include a self-formed loop 82 that can attach to the closing mechanism 36 by threading the cable 38 through the loop 82 during assembly of the apparatus 10. The specific attachment mechanisms may be varied without departing from the scope of the present invention.

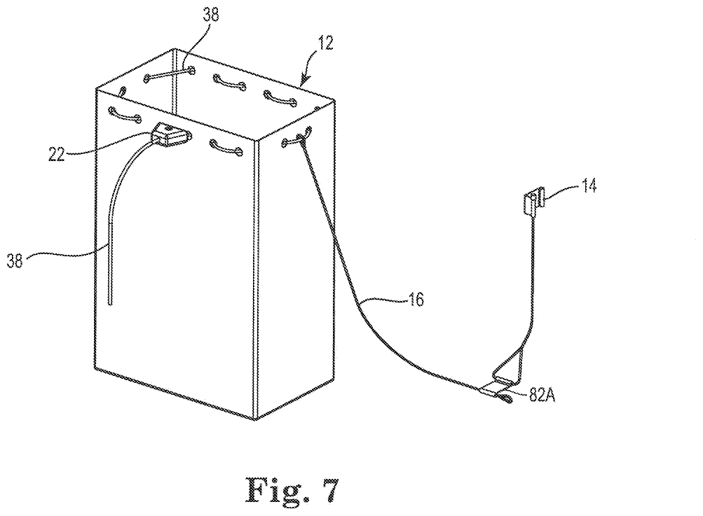

Some online purchasers live in structures with exterior doors with a separate screen door. In an alternate embodiment shown in FIG. 7, a first anchoring device 14 is provided to anchor the container to the main exterior door 20 (shown in FIG. 1) and a second anchoring device 82A is provided to anchor the tether 16 and container 12 between a screen door and a screen door jam (not shown). In climates where storm doors are common, it would be desirable to use both anchoring devices 14, 82A to secure the container 12 to the stationary structure. In other embodiments, the tether 16 is thin enough to fit between the bottom of the storm door and the threshold and no second locking mechanism 82A is needed.

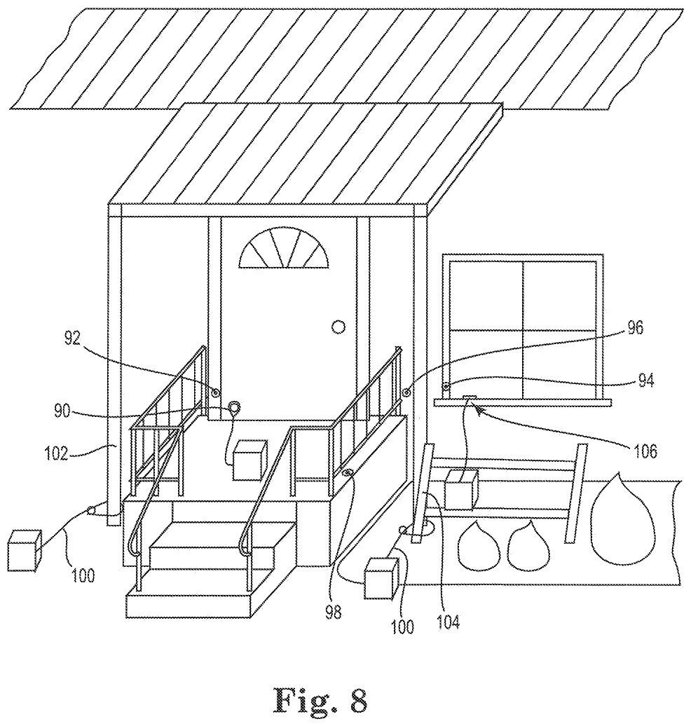

Although in one form of the invention, the anchoring mechanism is positionable between a door and door frame, the present invention contemplates other anchoring methods, as shown in FIG. 8. For example, a permanent eye bolt 90 can be installed directly in the front door, door frame 92, window frame 94 or directly through an exterior wall 96. A concrete anchor may be installed in a concrete stoop 98 or block foundation. Any type of permanent anchor could be fastened to a stationary structure and used as an anchor of the present invention. In another example, the tether and anchor are configured to attach to a door knob. Alternatively, the anchoring mechanism may be constructed with two looped ends, one end large enough for the other end to be threaded through the larger loop. This type of tether 100 can be anchored to the stationary structure by wrapping it around a post 102 and threading one end through the other, or by wrapping the tether 100 around a fence post 104. The anchoring device may be adapted to fit securely into a sliding window 106 or a sliding door (not shown), but in that event the locking mechanism of the door or window could be compromised, so the homeowner or apartment dweller would need to cut a pole or a piece of wood to insert in the track in order to prevent the thieves from opening the doors or windows.

According to methods of the present invention, an anchor is provided that can secure a tethering device to a stationary structure at a delivery location. The term “stationary” is meant to include moveable structures, but only those that require equipment such as a tow truck, crane, flatbed trailer, pickup truck or engine to move. For example, according to methods of the present invention, this system can be used to secure a package to a motor home or to a recreational vehicle or a moveable trailer, which is stationary for purposes of this disclosure.

According to examples of the invention, an anchoring device is provided that attaches to a stationary structure, such as an exterior door and door frame. A controlled access container is provided that is of a size and shape to receive a shipped package. The controlled access container has a closing mechanism that is lockable by the delivery person and unlockable by the recipient of the package. A tether is provided that secures the controlled access container to the locking mechanism. The locking mechanism and tether may be integrated as one component or may be provided as separate components assembled by the user.

According to an example of a method of the present invention, the anchor is removeable by the user. In other embodiments, the anchor is permanently installed, and the tether is removable between uses from the anchor. The tether may anchor the controlled access container to a stationary structure by wrapping the tether around the stationary structure and threading one looped end through the opposite looped end.

Online shoppers can secure packages to a stationary structure at a delivery location by using examples of this invention. Although not all package theft can be prevented, the system will be a major deterrent for people who compulsively grab and snatch packages that are in clear view from the road. In addition, it will deter thieves who attempt to access the controlled access containers using hand tools such as knives, wire snips, landscaping sheers and the like. Although the present invention may not prevent all package theft, it will deter compulsive thieves who grab, and snatch and it will add to the amount of time and effort needed to steal a package.

The above description only describes several examples of the invention. Other forms of the invention are contemplated and are within the spirit and scope of the claims presented.

What is claimed is:

1. An apparatus for securing a delivered package, comprising:
a moveable controlled access container adapted to receive a package delivered to a delivery location;
an anchoring device for anchoring the controlled access container to a stationary structure at the delivery location; and
a tether adapted to connect the controlled access container to the anchoring device.

2. The apparatus of claim 1, wherein the controlled access container is formed from multiple layers, at least one formed of a fabric.

3. The apparatus of claim 2, wherein the controlled access container comprises a security layer adjacent to a flexible fabric exterior.

4. The apparatus of claim 3, wherein the security layer comprises a flexible metal mesh structure.

5. The apparatus of claim 4, wherein the flexible metal mesh structure is selected from the group consisting of a wire rope mesh, wire mesh and expanded metal wire mesh.

6. The apparatus of claim 1, wherein the controlled access container comprises a closing mechanism, wherein the closing mechanism further comprises a locking mechanism.

7. The apparatus of claim 6, wherein the closing mechanism comprises a wire cable and a cable lock.

8. The apparatus of claim 1, wherein the controlled access container comprises a flexible bag with a base, four sides and a top edge.

9. The apparatus of claim 8, wherein the flexible bag has a security layer and a plurality of grommets spaced from the upper edge for threading the cable therethrough apertures in the grommets, and wherein the security layer extends to the top edge.

10. The apparatus of claim 1, wherein the anchoring device is a locking body shaped to fit around three adjacent surfaces of a hinged exterior door of a stationary structure.

11. The apparatus of claim 1, wherein the anchoring device includes a connector for connecting the anchoring device to the tethering device.

12. The apparatus of claim 1, wherein the tethering device is fixedly attached at one end to the anchoring device.

13. The apparatus of claim 12, wherein the tethering device is a metal cable with at least one loop at a first end.

14. The apparatus of claim 1, wherein the anchoring device is configured for anchoring to a stationary structure selected from the group consisting of: a door jam of a hinged door, a door jam of a sliding door, a window sill of a moveable window, an exterior wall of a building, a building frame, an exterior door, a door frame, a window frame, a post, a fence post, a poll, a cement slab and a foundation.

15. The apparatus of claim 1, wherein the anchoring device is removable or stationary.

16. The apparatus of claim 1, wherein the anchoring device is configured to anchor the controlled access container to a door knob or door handle.

17. A method of securing a package being delivered to a delivery location, comprising:
providing an anchor that is capable of securing a tethering device to a stationary structure at the delivery location;
providing a controlled access container that permits insertion of a package, wherein the container has a connecting mechanism for connection to the tether;
providing a tether that secures the anchor to the controlled access container and to the anchor; and
providing a locking mechanism on the controlled access container that secures a delivered package to the tether until the intended recipient of the package unlocks the locking mechanism.

18. The method of claim 17, wherein the anchor is insertable into a door hinge and becomes anchored between a door jam and an edge of a door when the door is closed and locked.

19. The method of claim 17, wherein the tether comprises a cable with at least one loop for connection to the controlled access container and an opposite end fixedly attached to the anchor.

20. A removeable anchoring mechanism configured for use with a pivoting door, comprising:
an elongated member with a length, width and thickness, configured to contact at three adjacent planes of a door, one of the planes comprising an edge of a door, having at least three portions, the first and second portions joined together at an angle of approximately 90 degrees, and the second and third portions joined together at an angle of approximately 90 degrees, wherein the elongated member is positionable on a door edge between the door and a door jam when the door is in a closed position;
an expanded portion on the first portion configured to prevent the elongated member from being pulled through the space between the door and an adjacent door jam when the door is in the closed position; and
a locking mechanism on the third portion for securing a tether to the anchoring mechanism.

21. The anchoring mechanism of claim 20, wherein the expanded portion is a rolled end.

22. The anchoring mechanism of claim 20, and further comprising a locking device at the second end configured for locking to a tether.

23. The anchoring mechanism of claim 20, wherein the locking device comprises a rolled end.

24. The anchoring mechanism of claim 20, and further comprising an elongated tether having a length, and a first end that is fixedly attached to the anchoring mechanism, wherein the tether has a fixed loop at the opposite end configured for connection to a controlled access container.

25. A locking device comprising:
a rolled end for receiving an end of a tether, wherein the end of a tether is positionable in the rolled end, and wherein the end of the tether is expanded such that the tether cannot be pulled through the rolled end.
